(19) United States
(12) Patent Application Publication
(10) Pub. No.: US 2023/0412764 A1
(43) Pub. Date: Dec. 21, 2023

(54) ANALYSIS APPARATUS, SYSTEM, METHOD, AND NON-TRANSITORY COMPUTER READABLE MEDIUM STORING PROGRAM

(71) Applicant: NEC Corporation, Minato-ku, Tokyo (JP)

(72) Inventors: Shin NORIEDA, Tokyo (JP); Yoshiyuki TANAKA, Tokyo (JP); Shogo AKASAKI, Tokyo (JP); Haruki YOKOTA, Tokyo (JP); Masami SAKAGUCHI, Tokyo (JP)

(73) Assignee: NEC Corporation, Minato-ku, Tokyo (JP)

(21) Appl. No.: 18/030,460

(22) PCT Filed: Oct. 12, 2020
(86) PCT No.: PCT/JP2020/038527

§ 371 Date: Apr. 5, 2023

(51) Int. Cl. H04N 7/15; G06T 7/11; G06V 40/16; G06F 3/14

(52) U.S. Cl. CPC H04N 7/152; G06T 7/11; G06T 2207/30201; G06V 40/174; G06F 3/1454; G06V 40/172

(57) ABSTRACT

An analysis apparatus comprises at least one memory storing instructions, and at least one processor configured to execute the instructions to acquire emotion data including time data from an emotion data generation apparatus that generates the emotion data from face image data of participants in an online meeting, acquire meeting data regarding the meeting including the time data, generate chapters for the meeting based on the meeting data, generate analysis data regarding the meeting based on the emotion data for each of the chapters, output the generated analysis data.

### TECHNICAL FIELD

The present invention relates to an analysis apparatus, a system, a method, and a program.

### BACKGROUND ART

Techniques for knowing emotions and the like of participants in a meeting have been proposed.

A meeting support system disclosed in Patent Literature 1 includes an emotion distinguishing portion for distinguishing emotions of attendants in accordance with entered video data and a text data generation portion for generating comment text data that indicate contents of speeches made by the attendants in accordance with the entered voice data. The meeting support system further includes a record generation portion for generating record data that include contents of a speech of an attendant and emotions of attendants when the speech was made, in accordance with emotion data that indicate a result of distinguishing made by the emotion distinguishing portion and the comment text data.

### CITATION LIST

### Patent Literature

[Patent Literature 1] Japanese Unexamined Patent Application Publication No. 2005-277462

### SUMMARY OF INVENTION

### Technical Problem

In an online meeting, participants who are present in places separated away from one another communicate with one another via terminals. It is therefore difficult to know what the atmosphere of the online meeting is and to know reactions of the participants to information shared in the online meeting.

The present disclosure has been made in view of the aforementioned problem and an aim of the present disclosure is to provide an analysis apparatus, an analysis method, an analysis system, and a program for efficiently managing an online meeting.

### Solution to Problem

An analysis apparatus according to one exemplary embodiment of the present disclosure includes emotion data acquisition means, meeting data acquisition means, chapter generation means, analysis data generation means, and output means. The emotion data acquisition means acquires emotion data including time data from an emotion data generation apparatus that generates the emotion data from face image data of participants in an online meeting. The meeting data acquisition means acquires meeting data regarding the meeting including the time data. The chapter generation means generates chapters for the meeting based on the meeting data. The analysis data generation means generates analysis data regarding the meeting based on the emotion data for each of the chapters. The output means outputs the generated analysis data.

An analysis method according to one exemplary embodiment of the present disclosure causes a computer to execute the following method. The computer acquires emotion data including time data from an emotion data generation apparatus that generates the emotion data from face image data of participants in an online meeting. The computer acquires meeting data regarding the meeting including the time data. The computer generates chapters for the meeting based on the meeting data. The computer generates analysis data regarding the meeting based on the emotion data for each of the chapters. The computer outputs analysis data.

A program according to one exemplary embodiment of the present disclosure causes a computer to execute the following steps. The computer acquires emotion data including time data from an emotion data generation apparatus that generates the emotion data from face image data of participants in an online meeting. The computer acquires meeting data regarding the meeting including the time data. The computer generates chapters for the meeting based on the meeting data. The computer generates analysis data regarding the meeting based on the emotion data for each of the chapters. The computer outputs the analysis data.

### Advantageous Effects of Invention

According to the present disclosure, it is possible to provide an analysis apparatus, an analysis method, an analysis system, and a program for efficiently managing an online meeting.

### BRIEF DESCRIPTION OF DRAWINGS

FIG. 1 is a block diagram showing a configuration of an analysis apparatus according to a first example embodiment;

FIG. 2 is a flowchart showing an analysis method according to the first example embodiment;

FIG. 3 is a block diagram showing a configuration of an analysis system according to a second example embodiment;

FIG. 4 is a block diagram showing a configuration of an analysis apparatus according to the second example embodiment;

FIG. 5 is a diagram showing an example of data processed by an analysis data generation unit;

FIG. 6 is a block diagram showing a configuration of an emotion data generation apparatus according to the second example embodiment;

FIG. 7 is a flowchart showing an analysis method according to the second example embodiment;

FIG. 8 is a diagram showing a first example of analysis data;

FIG. 9 is a diagram showing a second example of the analysis data;

FIG. 10 is a diagram showing an example of a relation between emotion data and a color space; and

FIG. 11 is a diagram showing a third example of the analysis data.

### EXAMPLE EMBODIMENT

In the following, with reference to the drawings, example embodiments of the present disclosure will be described in detail. Throughout the drawings, the same or corresponding elements are denoted by the same reference symbols and overlapping descriptions will be omitted as necessary for the sake of clarification of the description.

### First Example Embodiment

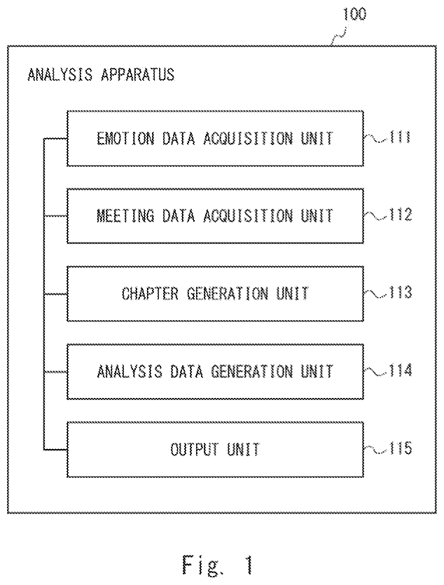

With reference to FIG. 1, a first example embodiment will be described. FIG. 1 is a block diagram showing a configuration of an analysis apparatus 100 according to the first example embodiment. The analysis apparatus 100 acquires emotion data of participants who participate in an online meeting, generates analysis data related to this online meeting from the acquired emotion data, and outputs the generated analysis data to a predetermined terminal or the like.

In this example embodiment, the online meeting means any meeting that is held using a plurality of meeting terminals connected to one another via a communication line in such a way that these meeting terminals can communicate with one another. The meeting terminal connected to the online meeting may be, for example, a personal computer, a smartphone, a tablet terminal, or a mobile phone equipped with a camera. Further, the meeting terminal is not limited to the aforementioned one as long as it is an apparatus including a camera that captures images of participants, a microphone that collects speeches of the participants, and a communication function that transmits and receives image data or voice data. In the following description, the online meeting may be simply referred to as a “meeting”.

The participants of the online meeting in this example embodiment indicate persons who access the online meeting via the meeting terminals and include the host of the meeting, speakers or presenters of the meeting, and observers of the meeting. When, for example, a plurality of persons participate in the meeting via one meeting terminal, each of these plurality of persons is a participant. In this example embodiment, it is assumed that the participants participate in the meeting in a state in which their face images can be captured by cameras included in the meeting terminals or connected to the meeting terminals.

The analysis apparatus 100 is connected to each of an emotion data generation apparatus that generates emotion data of the participants in the online meeting and a meeting management apparatus that manages the meeting in such a way that the analysis apparatus 100 can communicate with the emotion data generation apparatus and the meeting management apparatus. Further, the analysis apparatus 100 can be connected to a terminal (user terminal) that the user who uses the analysis apparatus 100 has in such a way that the analysis apparatus 100 can communicate with the terminal. The analysis apparatus 100 mainly includes an emotion data acquisition unit 111, a meeting data acquisition unit 112, a chapter generation unit 113, an analysis data generation unit 114, and an output unit 115.

The emotion data acquisition unit 111 acquires emotion data from the emotion data generation apparatus. The emotion data generation apparatus generates emotion data from the face image data of the participants during the online meeting and supplies the generated emotion data to the analysis apparatus 100. The emotion data is data, which is an index indicating the emotion that each of the participants in the meeting has.

The emotion data includes, for example, a plurality of items such as a level of attention, a level of confusion, a level of happiness, and surprise. That is, the emotion data shows the extent to which the participant is feeling these kinds of emotions for each of the aforementioned items. The emotion data acquired by the emotion data acquisition unit 111 includes time data. The emotion data generation apparatus generates emotion data for each predetermined period (e.g., one second). The emotion data acquisition unit 111 acquires emotion data for each predetermined time along a proceeding time of the meeting. Upon acquiring the emotion data, the emotion data acquisition unit 111 supplies the acquired emotion data to the analysis data generation unit 114.

The meeting data acquisition unit 112 acquires meeting data from the meeting management apparatus. The meeting management apparatus is, for example, a server apparatus that each of the participants of the meeting accesses in such a way that communication can be performed between them. The meeting management apparatus may be the one included in the meeting terminal used by the participant of the meeting. The meeting data is data regarding the meeting that includes time data. More specifically, the meeting data includes the start time and the end time of the meeting. The meeting data further includes a time of a break taken during the meeting.

The meeting data acquisition unit 112 may be the one that acquires meeting data including data regarding screen sharing in the meeting. In this case, the meeting data may include, for example, a time when the authority to operate the shared screen shared by the participants (owner of the shared screen) is switched or a time when the speech of the participant is switched. The meeting data acquisition unit 112 may acquire meeting data including screen data shared in the meeting. In this case, the meeting data may include a time when a page is forwarded in the shared screen or when a display image is changed. Further, the meeting data may include information indicating what each of the aforementioned times shows. The meeting data acquisition unit 112 supplies the acquired meeting data to the chapter generation unit 113 and the analysis data generation unit 114.

The chapter generation unit 113 generates chapters for the meeting from the meeting data received from the meeting data acquisition unit 112. The chapter generation unit 113 detects, for example, the time from the start of the meeting to the end of the meeting. The chapter generation unit 113 further detects times that match a preset condition and generates data indicating the chapters, each of the times being a break for the next chapter. The chapters in the meeting according to the present disclosure are defined based on whether a state in which the predetermined condition is met has been maintained in the meeting or the predetermined condition has been changed. The chapter generation unit 113 may generate chapters based on, for example, data regarding screen sharing. More specifically, the chapter generation unit 113 may generate a chapter in accordance with the timing when the screen sharing is switched. The chapter generation unit 113 may further generate a chapter in accordance with a time when the owner of the shared screen in the screen sharing is switched. The chapter generation unit 113 supplies the data indicating the generated chapter to the analysis data generation unit 114.

The analysis data generation unit 114 generates analysis data regarding the meeting for each of the chapters from the emotion data, the meeting data, and the data indicating chapters that have been received. The analysis data is data that is derived from the emotion data and is extracted or calculated from items indicating a plurality of kinds of emotions. The analysis data is preferably an index that helps to manage the meeting. For example, the analysis data may include the level of attention, the level of empathy, and the level of understanding for the meeting. Alternatively, the analysis data may be a level of transmission of emotions of the speaker to the observers of the meeting. Upon generating the analysis data for each chapter, the analysis data generation unit 114 supplies the generated analysis data to the output unit 115.

The output unit 115 outputs the analysis data generated by the analysis data generation unit 114 to a user terminal. The user who uses the analysis apparatus 100 is able to recognize what kind of emotion the participant has regarding the content of the meeting, the speech made by the presenter, or the like by perceiving the analysis data received by the user terminal. Therefore, the user is able to know, from the received analysis data, the matters that should be noted in a meeting that is held thereafter.

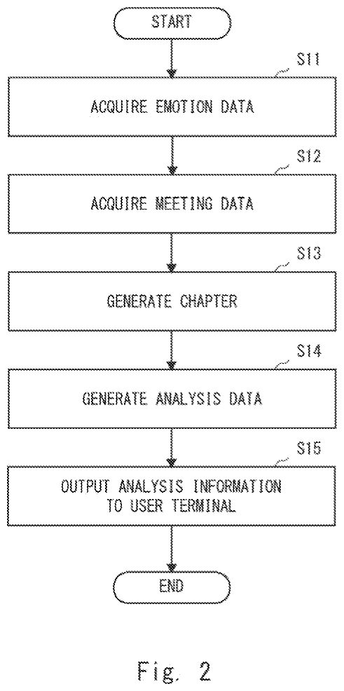

Referring next to FIG. 2, processing of the analysis apparatus 100 according to the first example embodiment will be described. FIG. 2 is a flowchart showing an analysis method according to the first example embodiment. The flowchart shown in FIG. 2 is started by the analysis apparatus 100 receiving, for example, a signal indicating the start of the meeting from the meeting management apparatus.

First, the emotion data acquisition unit 111 acquires emotion data from the emotion data generation apparatus (Step S11). The emotion data acquisition unit 111 may acquire the generated emotion data every time the emotion data generation apparatus generates the emotion data or may collectively acquire the emotion data at a plurality of different times.

Next, the meeting data acquisition unit 112 acquires meeting data regarding the meeting including time data (Step S12). The meeting data acquisition unit 112 may receive the meeting data for every predetermined period (e.g., one minute) or may receive the meeting data every time the meeting data includes information that should be updated. Further, the meeting data acquisition unit 112 may receive the meeting data after the meeting is ended.

Next, the chapter generation unit 113 generates a chapter from the meeting data received from the meeting data acquisition unit 112 (Step S13).

Next, the analysis data generation unit 114 generates analysis data regarding the meeting for each of the chapters from the emotion data received from the emotion data acquisition unit 111, the meeting data received from the meeting data acquisition unit 112, and the data indicating the chapters received from the chapter generation unit 113 (Step S14).

Next, the output unit 115 outputs the generated analysis data (Step S15). The processing performed by the analysis apparatus 100 has been described above. In the aforementioned processing, either Step S11 or Step S12 may be performed first. Further, Step S11 and Step S12 may be executed in parallel to each other. Alternatively, Step S11 and Step S12 may be alternately executed for each predetermined period.

The first example embodiment has been described above. As described above, the analysis apparatus 100 according to the first example embodiment acquires the emotion data and the meeting data of the participants in the online meeting, generates chapters from the meeting data, and generates analysis data regarding the meeting for each of the chapters in the meeting. Accordingly, the user who uses the analysis apparatus 100 is able to make communications in accordance with the tendency of the emotion of the participant in the online meeting. Therefore, according to this example embodiment, it is possible to provide the analysis apparatus, the analysis method, the analysis system, and the program for efficiently managing the online meeting.

The analysis apparatus 100 includes a processor and a storage apparatus as components that are not shown. The storage apparatus included in the analysis apparatus 100 includes a storage apparatus including a non-volatile memory such as a flash memory or a Solid State Drive (SSD). The storage apparatus that the analysis apparatus 100 includes may store a computer program (hereinafter it may also be simply referred to as a program) for executing the analysis method according to this example embodiment. Further, the processor loads a computer program into a memory from a storage apparatus and executes this program.

Each of the components that the analysis apparatus 100 includes may be implemented by dedicated hardware. Further, some or all of the components may each be implemented by general-purpose or dedicated circuitry, processor, or a combination of them. They may be configured using a single chip, or a plurality of chips connected through a bus. Some or all of the components of each apparatus may be implemented by a combination of the above-described circuitry, etc. and a program. Further, a Central Processing Unit (CPU), a Graphics Processing Unit (GPU), a field-programmable gate array (FPGA) and so on may be used as a processor.

Further, when some or all of the components of the analysis apparatus 100 are implemented by a plurality of computation apparatuses, circuits, or the like, the plurality of computation apparatuses, the circuits, or the like may be disposed in one place in a centralized manner or arranged in a distributed manner. For example, the computation apparatuses, the circuits, and the like may be implemented as a form such as a client-server system, a cloud computing system or the like in which the apparatuses or the like are connected to each other through a communication network. Alternatively, the functions of the analysis apparatus 100 may be provided in the form of Software as a Service (SaaS).

### Second Example Embodiment

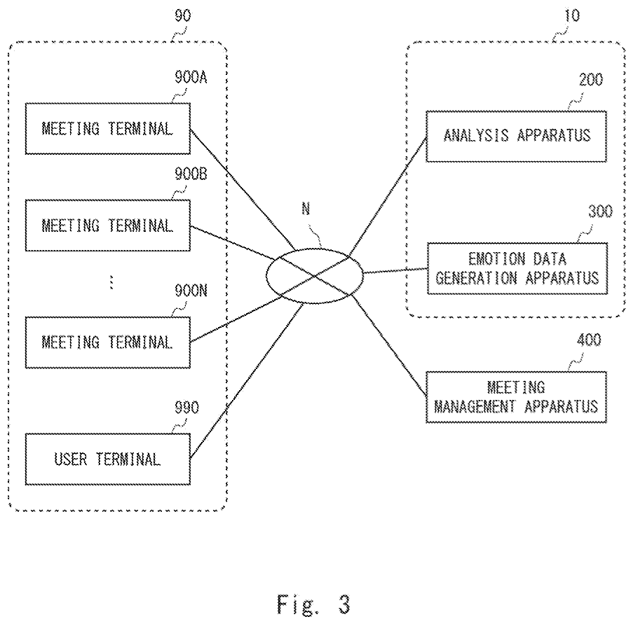

Next, a second example embodiment will be described. FIG. 3 is a block diagram showing a configuration of an analysis system according to the second example embodiment. An analysis system 10 shown in FIG. 3 includes an analysis apparatus 200 and an emotion data generation apparatus 300. The analysis apparatus 200 and the emotion data generation apparatus 300 are connected to each other via a network N in such a way that they can communicate with each other. Further, the analysis system 10 is connected to a meeting management apparatus 400 via the network N in such a way that the analysis system 10 can communicate with the meeting management apparatus 400. The meeting management apparatus 400 is connected to a meeting terminal group 90 via the network N and manages an online meeting. The meeting terminal group 90 includes a plurality of meeting terminals (900A, 900B, . . . , 900N) and a user terminal 990.

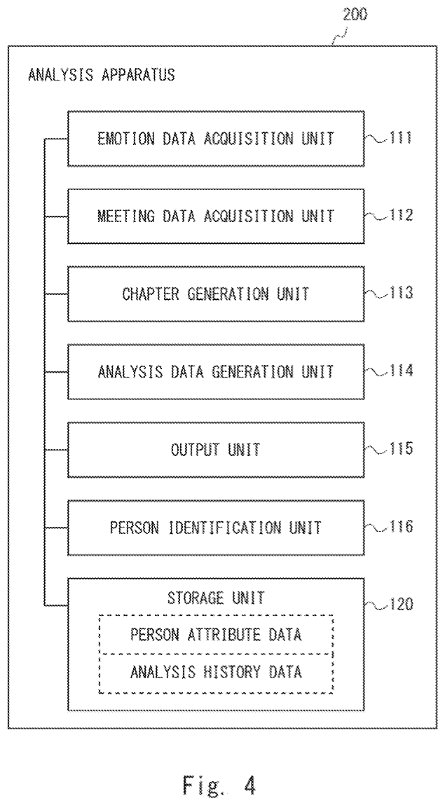

Referring next to FIG. 4, an analysis apparatus according to the second example embodiment will be described. FIG. 4 is a block diagram showing a configuration of the analysis apparatus 200 according to the second example embodiment. The analysis apparatus 200 according to the second example embodiment is different from the analysis apparatus 100 according to the first example embodiment in that the analysis apparatus 200 according to the second example embodiment includes a person identification unit 116 and a storage unit 120. Hereinafter, each of the components of the analysis apparatus 200 will be described, including differences between the analysis apparatus 200 and the analysis apparatus 100.

The emotion data acquisition unit 111 according to this example embodiment acquires emotion data in which a plurality of indices indicating the states of the emotions are shown by numerical values. The analysis data generation unit 114 generates analysis data by calculating statistical values of the emotion data in a predetermined period.

The meeting data acquisition unit 112 acquires meeting data from the meeting management apparatus 400 that manages the meeting. The meeting data acquisition unit 112 may acquire meeting data including attribute data of the meeting. The attribute data of the meeting may include, for example, information indicating the type of the meeting such as Webinar (this is also referred to as a web seminar or an online seminar), a regular meeting, or brainstorming. The attribute data of the meeting may also include information regarding the type of business of the company for which participants of the meeting work or the categories of the job of these participants. Further, the attribute data of the meeting may also include information regarding the theme of the meeting, the purpose of the meeting, or the name of a meeting group. Further, the meeting data acquisition unit 112 may acquire face image data of the participant from the meeting management apparatus 400. The meeting data acquisition unit 112 supplies the acquired face image data to the person identification unit 116.

The analysis data generation unit 114 may generate analysis data by selecting a method for calculating the analysis data based on the attribute data of the meeting. According to the aforementioned configuration, the analysis apparatus 200 is able to generate the analysis data in accordance with the attribute of the meeting.

The analysis data generation unit 114 may generate analysis data by relatively comparing a plurality of different meetings. That is, the analysis data generation unit 114 may generate analysis data including a result of a relative comparison of the meeting that corresponds to attribute data based on the attribute data of the meeting and the analysis history data. In this case, the analysis data generation unit 114 reads analysis history data stored in the storage unit 120 and compares the data regarding the meeting which is to be newly analyzed with past data that may be compared with the above data. In this case, the analysis data generation unit 114 determines whether two data items are to be analyzed by comparing the attribute data of the meeting.

Further, the analysis data generation unit 114 receives predetermined data that will be described later from the person identification unit 116 and generates analysis data in accordance with the participant in the meeting using the received data. The predetermined data received from the person identification unit 116 is, for example, data indicating the segmentation of the participant. In this case, the analysis data generation unit 114 is able to generate analysis data in view of the segmentation of the participant. Further, the predetermined data received from the person identification unit 116 is, for example, data for identifying a participant. In this case, the analysis data generation unit 114 is able to generate analysis data associated with the identified participant.

The person identification unit 116 may include a function of extracting the face feature information of the person in the face image from the face image data and estimating the segmentation to which the person belongs in accordance with the extracted information. The segmentation to which the person belongs indicates, for example, features or attributes of the person such as the age or the sex of the person. The person identification unit 116 identifies, using the aforementioned function, the segmentation to which the participant in the face image data received from the meeting data acquisition unit 112 belongs. The person identification unit 116 supplies the data regarding the segmentation of the person to the analysis data generation unit 114.

The person identification unit 116 may further identify the segmentation to which the identified participant belongs using the person attribute data stored in the storage unit 120. In this case, the person identification unit 116 associates the face feature information extracted from the face image with the person attribute information stored in the storage unit 120, and identifies the segmentation of the participant who corresponds to the face feature information. The segmentation of the participant here is, for example, the legal entity to which the participant belongs, the department in the legal entity, the category of the job or the like of the participant. According to this configuration, the analysis apparatus 200 is able to extract data that can be used for the analysis data while protecting the participants' privacy.

Further, the person identification unit 116 may identify the person in the face image from the face image data received from the meeting data acquisition unit 112. In this case, the person identification unit 116 associates the face feature information extracted from the face image with the person attribute data stored in the storage unit 120 and identifies the participant who corresponds to the face feature information. Accordingly, the person identification unit 116 is able to identify each of the participants in the meeting. By identifying the participants in the meeting, the analysis apparatus 200 is able to generate analysis data associated with the identified participant. Therefore, the analysis apparatus 200 is able to conduct a detailed analysis on the identified participant.

The storage unit 120 is a storage apparatus including a non-volatile memory such as an SSD or a flash memory. The storage unit 120 stores person attribute data and analysis history data. The person attribute data is data in which the face feature information of the person is associated with information regarding the segmentation or the attribute of the person. The information regarding the segmentation or the attribute of the person includes, for example, but not limited to, the name of the person, the sex of the person, the age of the person, the category of the job, the legal entity or the department to which this person belongs. The analysis history data is analysis data regarding the analysis that the analysis apparatus 200 has executed in the past, that is, analysis data that the analysis data generation unit 114 of the analysis apparatus 200 has generated in the past. Note that the storage unit 120 stores, for example, besides the aforementioned data, a program or the like for executing the analysis method according to this example embodiment.

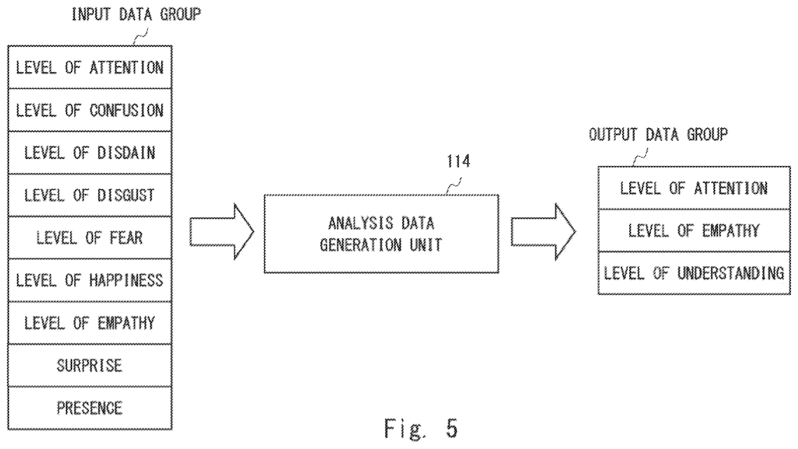

Referring to FIG. 5, the analysis data generation unit 114 will be further described. FIG. 5 is a diagram showing an example of data processed by the analysis data generation unit. FIG. 5 shows an input data group received by the analysis data generation unit 114 and an output data group output by the analysis data generation unit 114. The analysis data generation unit 114 receives emotion data as the input data group from the emotion data generation apparatus 300. The input data group includes, for example, respective indices regarding a level of attention, a level of confusion, a level of disdain, a feeling of disgust, a feeling of fear, a level of happiness, a level of empathy, surprise, and the presence. These indices are indicated, for example, by numerical values from 0 to 100. The indices here indicate, for example, that the larger the value is, the larger the reaction of the participant to the emotion is. The emotion data of the input data group acquired may be the one generated from the face image data using the existing video processing technique or may be generated or acquired by another method.

Upon receiving the aforementioned input data group, the analysis data generation unit 114 performs preset processing and generates output data group using the input data group. The output data group is data that the user who uses the analysis system 10 refers to in order to efficiently conduct the meeting. The output data group includes, for example, a level of attention, a level of empathy, and a level of understanding. The analysis data generation unit 114 extracts the preset index from the input data group. The analysis data generation unit 114 further performs preset computation processing on the value of the extracted index. The analysis data generation unit 114 then generates the aforementioned output data group. The level of attention indicated as the output data group may be the same as or different from the level of attention included in the input data group. Likewise, the level of empathy indicated as the output data group may be the same as or different from the level of empathy included in the input data group.

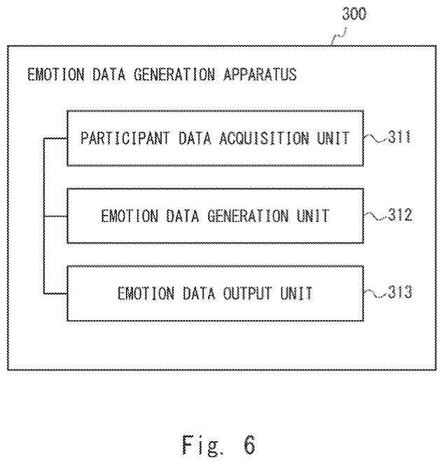

Referring next to FIG. 6, the emotion data generation apparatus 300 will be described. FIG. 6 is a block diagram showing a configuration of the emotion data generation apparatus according to the second example embodiment. The emotion data generation apparatus 300 mainly includes a participant data acquisition unit 311, an emotion data generation unit 312, and an emotion data output unit 313.

The participant data acquisition unit 311 acquires data regarding the participants from the meeting management apparatus 400. The data regarding the participants is face image data of the participants captured by the meeting terminal. The emotion data generation unit 312 generates emotion data from the face image data received by the emotion data generation apparatus 300. The emotion data output unit 313 outputs the emotion data generated by the emotion data generation unit 312 to the analysis apparatus 200 via the network N. Note that the emotion data generation apparatus 300 generates the emotion data by performing predetermined image processing on the face image data of the participants. The predetermined image processing is, for example, extraction of feature points (or feature amount), comparison between the extracted feature points with reference data, convolution processing of image data and processing using machine-learned teaching data, processing using teaching data by deep learning or the like. Note that the method in which the emotion data generation apparatus 300 generates the emotion data is not limited to the aforementioned processing. The emotion data may be numerical values, which are indices indicating emotions or may include the one including image data used when the emotion data is generated.

The emotion data generation apparatus 300 includes, as components that are not shown, a processor and a storage apparatus. The storage apparatus included in the emotion data generation apparatus 300 stores a program for executing generation of the emotion data according to this example embodiment. Further, the processor loads a program into a memory from a storage apparatus and executes this program.

Each of the components that the emotion data generation apparatus 300 includes may be implemented by dedicated hardware. Further, some or all of the components may each be implemented by general-purpose or dedicated circuitry, processor, or a combination of them. They may be configured using a single chip, or a plurality of chips connected through a bus. Some or all of the components of each apparatus may be implemented by a combination of the above-described circuitry, etc. and a program. Further, a CPU, a GPU, a FPGA and so on may be used as a processor.

Further, when some or all of the components of the emotion data generation apparatus 300 are implemented by a plurality of computation apparatuses, circuits, or the like, the plurality of computation apparatuses, the circuits, or the like may be disposed in one place in a centralized manner or arranged in a distributed manner. For example, the computation apparatuses, the circuits and the like may be implemented as a form such as a client-server system, a cloud computing system or the like in which the apparatuses or the like are connected to each other through a communication network. Alternatively, the functions of the emotion data generation apparatus 300 may be provided in the form of SaaS.

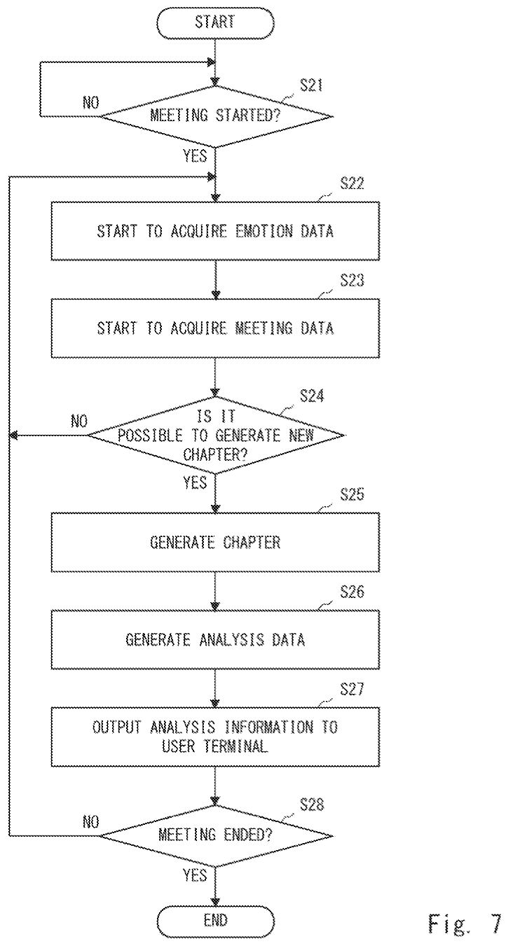

Referring next to FIG. 7, processing executed by the analysis apparatus 200 will be described. FIG. 7 is a flowchart showing the analysis method according to the second example embodiment. The processing shown in FIG. 7 is different from the processing according to the first example embodiment in that the analysis data is output every time a new chapter is generated in the meeting that is being held.

First, the analysis apparatus 200 determines whether or not the online meeting has been started (Step S21). The analysis apparatus 200 determines that the meeting has been started by receiving a signal indicating that the meeting has been started from the meeting management apparatus 400. When it is not determined that the online meeting has been started (Step S21: NO), the analysis apparatus 200 repeats Step S21. When it is determined that the online meeting has been started (Step S21: YES), the analysis apparatus 200 proceeds to Step S22.

In Step S22, the emotion data acquisition unit 111 starts to acquire the emotion data from the emotion data generation apparatus (Step S22). The emotion data acquisition unit 111 may acquire the generated emotion data every time the emotion data generation apparatus generates the emotion data or may collectively acquire the emotion data at a plurality of different times.

Next, the meeting data acquisition unit 112 acquires the meeting data regarding the meeting that includes time data (Step S23). The meeting data acquisition unit 112 may receive this meeting data for every predetermined period (e.g., one minute) or may receive the meeting data every time the meeting data includes information that should be updated.

Next, the analysis apparatus 200 determines whether or not it is possible to generate a new chapter from the received meeting data (Step S24). When it is not determined that a new chapter can be generated (Step S24: NO), the analysis apparatus 200 returns to Step S22. On the other hand, when the analysis apparatus 200 has determined that it is possible to generate a new chapter (Step S24: YES), the analysis apparatus 200 proceeds to Step S25.

In Step S25, the chapter generation unit 113 generates a chapter from the meeting data received from the meeting data acquisition unit 112 (Step S25).

Next, the analysis data generation unit 114 generates analysis data regarding the newly generated chapter from the emotion data received from the emotion data acquisition unit 111, the meeting data received from the meeting data acquisition unit 112, the data indicating the chapters received from the chapter generation unit 113, and the data received from the person identification unit 116 (Step S26).

Next, the output unit 115 outputs the generated analysis data to the user terminal 990 (Step S27). Further, the analysis apparatus 200 determines whether or not the meeting has ended (Step S28). The analysis apparatus 200 determines that the meeting has ended by receiving a signal indicating that the meeting has ended from the meeting management apparatus 400. When it is not determined that the meeting has ended (Step S28: NO), the analysis apparatus 200 returns to Step S22 and continues the processing. On the other hand, when it is determined that the online meeting has ended (Step S28: YES), the analysis apparatus 200 ends the series of processing.

The processing of the analysis apparatus 200 according to the second example embodiment has been described above. According to the aforementioned flowchart, the analysis apparatus 200 is able to output the analysis data for a chapter generated every time a new chapter is generated in the meeting that is being held. Accordingly, the user who uses the analysis system 10 is able to efficiently conduct a meeting using the analysis data that is provided every time a new chapter is generated in the meeting that is being held. Alternatively, the user is able to achieve smooth communication in the meeting that is being held using the analysis data that is provided every time a new chapter is generated.

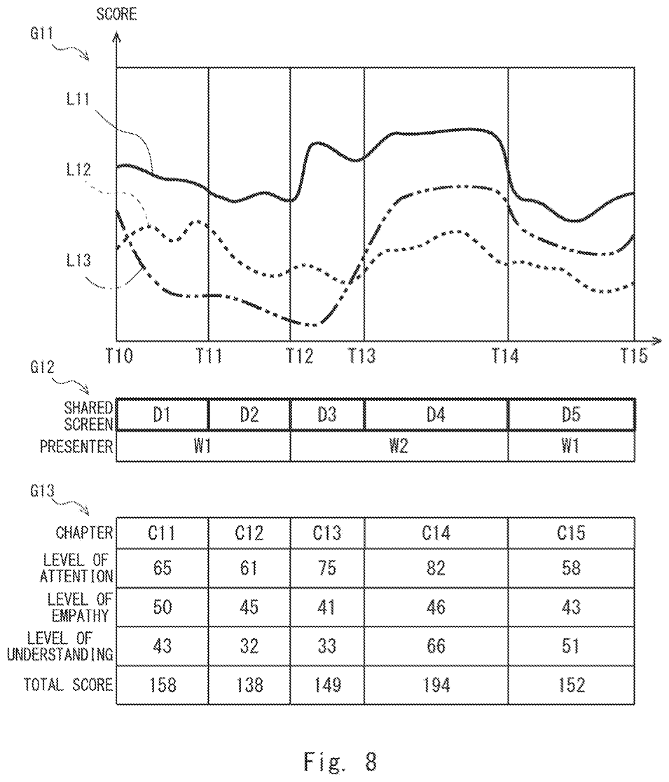

Referring next to FIG. 8, an example of the analysis data will be described. FIG. 8 is a diagram showing a first example of the analysis data. FIG. 8 shows, in the upper stage, a graph G11 that shows each of the analysis data items in a time series. FIG. 8 shows, in the middle stage, meeting data G12 that corresponds to the above time series. FIG. 8 shows, in the lower stage, analysis data G13 for each chapter that corresponds to the above meeting data.

In the graph G11, the horizontal axis indicates time and the vertical axis indicates the score of the analysis data. The left end of the horizontal axis is time T10, the time elapses as it moves to the right, and the right end is time T15. The time T10 corresponds to the start time of the meeting and time T15 corresponds to the end time of the meeting. The times T11, T12, T13, and T14 between time T10 and time T15 indicate the times that correspond to chapters that will be described later.

Further, in the graph G11, first analysis data L11 shown by a solid line, second analysis data L12 shown by a dotted line, and third analysis data L13 shown by an alternate long and two short dashes line are plotted. The first analysis data L11 indicates the level of attention in the analysis data. The second analysis data L12 indicates the level of empathy in the analysis data. The third analysis data L13 indicates the level of understanding in the analysis data.

The meeting data G12 shows data regarding the shared screen of the meeting and data regarding the presenter in a time series. That is, data regarding the display screen indicates that the shared screen from time T10 to time T11 has been a screen D1. Further, the data regarding the display screen indicates that the shared screen from time T11 to time T12 has been a screen D2. Likewise, the meeting data G12 indicates that the shared screen in the meeting has been a screen D3 from time T12 to time T13, a screen D4 from time T13 to time T14, and a screen D5 from time T14 to time T15.

Further, in the meeting data G12, the data regarding the presenter indicates that the presenter has been a presenter W1 from time T10 to time T12. Likewise, the data regarding the presenter indicates that the presenter has been a presenter W2 from time T12 to time T14 and that the presenter has been the presenter W1 again from time T14 to time T15.

The relation between the shared screen and the presenter in the aforementioned meeting data G12 will be described in a time series. The presenter W1 proceeds with the meeting from time T10 when the meeting has been started to time T12 and the presenter W1 has displayed the screen D1 as a shared screen (i.e., share the screen D1) from time T10 to time T11. Next, the presenter W1 has continued the presentation after switching the shared screen from the screen D1 to the screen D2 from time T11 to time T12. Next, at time T12, the presenter has been switched from the presenter W1 to the presenter W2. The presenter W2 has shared the screen D3 between time T12 and time T13 and shared the screen D4 between time T13 and time T14. In the period between time T14 and time T15, the presenter W1 replaced by the presenter W2 has shared the screen D5.

The relation between the shared screen and the presenter in the meeting data G12 has been described above in a time series. As described above, the meeting data shown in FIG. 8 includes data regarding the period during which the screen data is displayed on the shared screen and data indicating who the presenter is. The chapter generation unit 113 is able to generate chapters in accordance with data regarding the shared screen of the aforementioned meeting data.

The analysis data G13 shows data indicating chapters that correspond to the aforementioned meeting data, and the analysis data corresponding to the chapter in a time series. In the example shown in FIG. 8, data indicating chapters corresponds to data regarding the shared screen of the meeting data. That is, the first chapter C11 is a period from time T10 to T11 during which the screen D1 has been shared. Likewise, the second chapter C12 is a period from time T11 to time T12 during which the screen D2 has been shared. The third chapter C13 is a period from time T12 to time T13 during which the screen D3 has been shared. The fourth chapter C14 is a period from time T13 to time T14 during which the screen D4 has been shared. The fifth chapter C15 is a period from time T14 to time T15 during which the screen D5 has been shared.

As shown in FIG. 8, the analysis data G13 includes analysis data that corresponds to each chapter. The analysis data shows the level of attention, the level of empathy, the level of understanding, and a total score obtained by summing them up. The analysis data G13 shows, for example, as the analysis data that corresponds to the chapter C11, that the level of attention is 65, the level of empathy is 50, and the level of understanding is 43. Further, the analysis data G13 shows 158 as the total score. Likewise, the analysis data G13 shows, for example, as the analysis data that corresponds to the chapter C12, that the level of attention is 61, the level of empathy is 45, the level of understanding is 32, and the total score is 138.

The aforementioned analysis data corresponds to data plotted in the graph G11. That is, the analysis data shown as the analysis data G13 is an average value of the analysis data calculated in the period of the corresponding chapter for every predetermined period (e.g., one minute).

The examples of the analysis data have been described above. In the example shown in FIG. 8, the chapter generation unit 113 sets the timing when the shared screen is switched of the meeting data as the timing when the chapter is switched. Then the analysis data generation unit 114 calculates the analysis data in the period from the start of the meeting to the end of the meeting for each of the aforementioned chapters. Accordingly, the analysis system 10 is able to provide analysis data for each shared screen that is displayed.

In the example shown in FIG. 8, as shown in the aforementioned graph G11, the analysis system 10 calculates the analysis data for each predetermined period and plots them. Accordingly, the analysis system 10 is able to show detailed changes in the analysis data in the meeting. Instead of calculating the analysis data as shown in the graph G11, the analysis data generation unit 114 may calculate statistical values (e.g., an average value) of the emotion data in the chapter after the chapter is ended and then calculate the analysis data thereafter. According to the aforementioned configuration, the analysis system 10 is able to improve the speed at which the analysis data is processed.

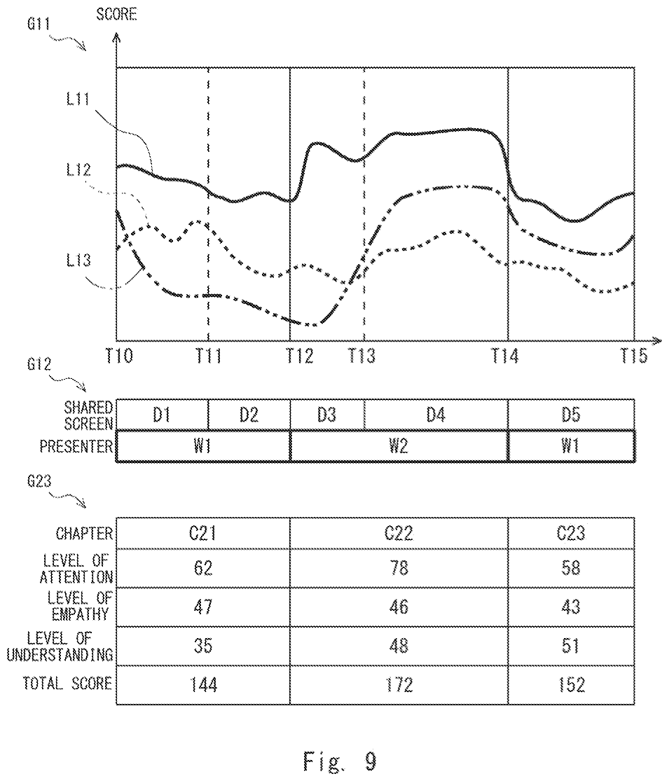

Referring next to FIG. 9, another example of the analysis data will be further described. FIG. 9 is a diagram showing a second example of the analysis data. In FIG. 9, the first analysis data L11, the second analysis data L12, and the third analysis data L13 shown in the graph G11 in the upper stage are the same as those shown in FIG. 8. Further, the meeting data G12 in the middle stage is the same as that shown in FIG. 8.

In FIG. 9, analysis data G23 shown in the lower stage is different from the analysis data shown in FIG. 8 in that the data for generating the chapters is data regarding presenters in the analysis data G23 shown in the lower stage. That is, in the example shown in FIG. 9, the chapter generation unit 113 sets a period from time T10 to time T12 during which the presenter W1 has been a presenter, as a first chapter C21. Likewise, the chapter generation unit 113 sets a period from time T12 to time T14 during which the presenter W2 has been a presenter, as a second chapter C22. Further, the chapter generation unit 113 sets a period from time T14 to time T15 during which the presenter W1 has been a presenter as a third chapter C23.

In FIG. 9, the analysis data is shown to correspond to the aforementioned chapters C21-C23. That is, the analysis data that corresponds to the chapter C21 shows that the level of attention is 62, the level of empathy is 47, the level of understanding is 35, and the total score is 144. The analysis data that corresponds to the chapter C22 shows that the level of attention is 78, the level of empathy is 46, the level of understanding is 48, and the total score is 172. The analysis data that corresponds to the chapter C23 shows that the level of attention is 58, the level of empathy is 43, the level of understanding is 51, and the total score is 152.

The second example of the analysis data has been described above. In the example shown in FIG. 9, the chapter generation unit 113 sets the timing when the presenter is switched of the meeting data as the timing when the chapter is switched. Then, the analysis data generation unit 114 calculates the analysis data from the start of the meeting to the end of the meeting for each of the aforementioned chapters. Accordingly, the analysis system 10 is able to provide analysis data for each presenter.

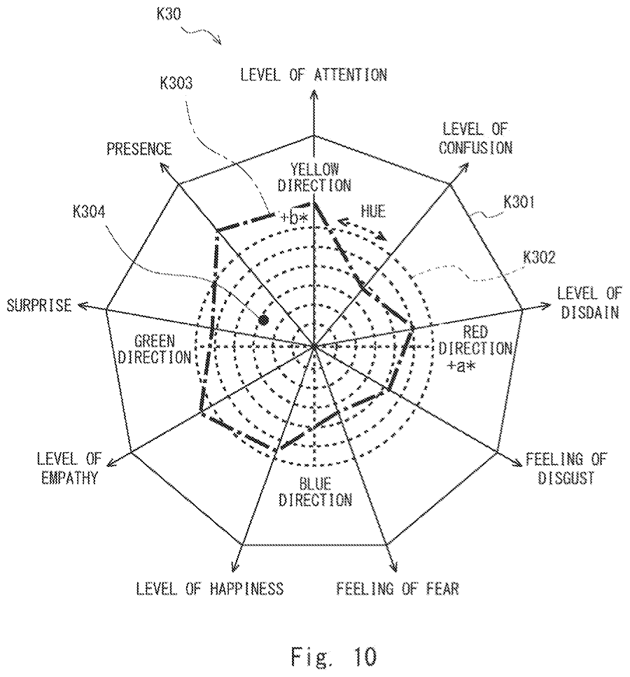

Next, a third example of the analysis data will be described. The example shown below is different from the aforementioned first and second examples in that the analysis data is qualitatively shown in the example shown below. FIG. 10 is a diagram showing an example of a relation between the emotion data and the color space.

FIG. 10 shows a chart K30. The chart K30 includes a radar chart K301 showing nine emotion data items output from the emotion data generation apparatus 300 radially, and a Lab color space K302. The radar chart K301 and the Lab color space K302 are superimposed upon each other in such a way that the centers thereof match each other. The Lab color space K302 is a color space in which the circumference direction indicates hue and the radial direction indicates color saturation. In the following description, the Lab color space may be simply referred to as a color space.

In the aforementioned chart K30, emotion data K303 shown by a thick alternate long and short dash line is plotted. The emotion data K303 is obtained by plotting the emotion data output from the emotion data generation apparatus 300 in the radar chart K301. The emotion data K303 is plotted as a polygonal line in a nonagon shown as the radar chart K301. Analysis data K304 is plotted as points inside the emotion data K303. The analysis data K304 shows points derived from the emotion data K303. The analysis data K304 is plotted on the Lab color space K302 inside the emotion data K303. In this way, in the example shown in FIG. 10, the emotion data is plotted on a point on the color space.

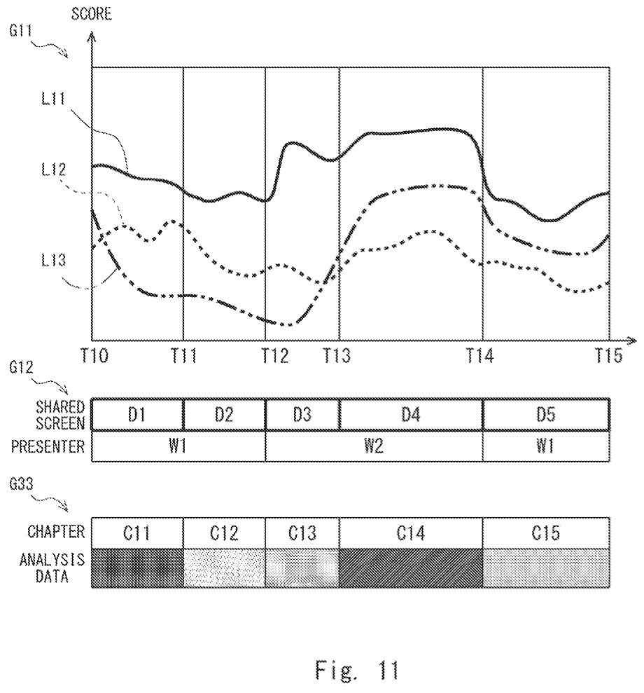

Next, with reference to FIG. 11, a third example of the analysis data will be further described. FIG. 11 is a diagram showing a third example of the analysis data. The graph G11 shown in the upper stage and the meeting data G12 shown in the middle stage in FIG. 10 are the same as those shown in FIG. 8.

The analysis data G33 shown in the lower stage in FIG. 11 is different from the analysis data shown in FIG. 8 in that the analysis data is shown by colors in the analysis data G33 shown in the lower stage in FIG. 11. That is, in the example shown in FIG. 11, the chapter generation unit 113 plots the analysis data for each chapter on one point on the color space using the chart K30 shown in FIG. 10, and shows the color at the plotted point in the analysis data G33.

The third example of the analysis data has been described above. The emotion data acquisition unit 111 acquires emotion data in which a plurality of indices indicating the states of the emotions are indicated by numerical values, and the analysis data generation unit 114 generates data that shows a plurality of emotion data items by color tones based on the preset index as the analysis data. In the third example of the analysis data, the timing when the shared screen is switched of the meeting data is set as the timing when the chapter is switched. Then the analysis data generation unit 114 displays the analysis data by color tones plotted in the color space. Accordingly, the analysis system 10 is able to qualitatively show the results of the analysis data in the meeting. Therefore, the user is able to intuitively know the analysis data.

While the analysis data is shown by the Lab color space in FIG. 10, in the third example of the analysis data, the analysis data may be shown by another color space. For example, the analysis system 10 may show the analysis data by “Plutchik's wheel of emotions”. In this case, the analysis system 10 plots the analysis data in the Plutchik's wheel of emotions and displays the analysis data by the color tones in the positions of the plots. Accordingly, the user who uses the analysis data is able to intuitively know the tendency of the emotion in the meeting from the analysis data.

While the second example embodiment has been described above, the configuration of the analysis system 10 according to the second example embodiment is not limited to the aforementioned one. For example, the analysis system 10 may include a meeting management apparatus 400. In this case, the analysis apparatus 200, the emotion data generation apparatus 300, and the meeting management apparatus 400 may be provided separately from one another or some or all of them may be integrated. Further, for example, the function that the emotion data generation apparatus 300 includes may be formed as a program and included in the analysis apparatus 200 or the meeting management apparatus 400.

The aforementioned program(s) can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), CD-Read Only Memory (ROM), CD-R, CD-R/W, semiconductor memories (such as mask ROM, Programmable ROM (PROM), Erasable PROM (EPROM), flash ROM, Random Access Memory (RAM), etc.). Further, the program(s) may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Note that the present invention is not limited to the aforementioned example embodiments and may be changed as appropriate without departing from the spirit of the present invention.

The whole or part of the example embodiments disclosed above can be described as, but not limited to, the following supplementary notes.

(Supplementary Note 1)

An analysis apparatus comprising:
emotion data acquisition means for acquiring emotion data including time data from an emotion data generation apparatus that generates the emotion data from face image data of participants in an online meeting;
meeting data acquisition means for acquiring meeting data regarding the meeting that includes time data;
chapter generation means for generating chapters for the meeting based on the meeting data;
analysis data generation means for generating analysis data for the meeting based on the emotion data for each of the chapters; and
output means for outputting the generated analysis data.

(Supplementary Note 2)

The analysis apparatus according to Supplementary Note 1, wherein
the meeting data acquisition means acquires meeting data including data regarding screen sharing in the meeting, and
the chapter generation means generates the chapters based on the data regarding the screen sharing.

(Supplementary Note 3)

The analysis apparatus according to Supplementary Note 2, wherein the chapter generation means generates the chapters in accordance with a timing when the screen sharing is switched.

(Supplementary Note 4)

The analysis apparatus according to Supplementary Note 2 or 3, wherein the chapter generation means generates the chapter in accordance with a time when the owner of the shared screen in the screen sharing is switched.

(Supplementary Note 5)

The analysis apparatus according to any one of Supplementary Notes 1 to 4, wherein the meeting data acquisition means acquires meeting data including screen data shared in the meeting.

(Supplementary Note 6)

The analysis apparatus according to any one of Supplementary Notes 1 to 5, wherein the meeting data acquisition means acquires the meeting data from a meeting management apparatus that manages the meeting.

(Supplementary Note 7)

The analysis apparatus according to any one of Supplementary Notes 1 to 6, wherein
the meeting data acquisition means acquires meeting data including attribute data of the meeting, and
the analysis data generation means generates the analysis data by selecting a method for calculating the analysis data based on the attribute data.

(Supplementary Note 8)

The analysis apparatus according to Supplementary Note 7, further comprising storage means for storing analysis history data regarding the analysis data that has been generated in the past, wherein
the analysis data generation means generates the analysis data including a result of a relative comparison of the meeting that corresponds to the attribute data based on the attribute data of the meeting and the analysis history data.

(Supplementary Note 9)

The analysis apparatus according to any one of Supplementary Notes 1 to 8, further comprising person identification means for identifying a person based on face image data, wherein
the meeting data acquisition means acquires the face image data of the participant,
the person identification means identifies segmentation to which the participant belongs from the face image data, and
the analysis data generation means generates the analysis data in view of the segmentation.

(Supplementary Note 10)

The analysis apparatus according to any one of Supplementary Notes 1 to 8, further comprising person identification means for identifying a person based on face image data, wherein
the meeting data acquisition means acquires the face image data of the participant,
the person identification means identifies the participant from the face image data, and
the analysis data generation means generates the analysis data of the participant regarding the identification.

(Supplementary Note 11)

The analysis apparatus according to any one of Supplementary Notes 1 to 10, wherein
the emotion data acquisition means acquires the emotion data in which a plurality of indices indicating the states of the emotions are indicated by numerical values, and
the analysis data generation means generates the analysis data by calculating a statistical value of the emotion data in a predetermined period.

(Supplementary Note 12)

The analysis apparatus according to any one of Supplementary Notes 1 to 10, wherein
the emotion data acquisition means acquires the emotion data in which a plurality of indices indicating the states of the emotions are indicated by numerical values, and
the analysis data generation means generates data in which a plurality of pieces of the emotion data are shown as color tones based on a preset index as the analysis data.

(Supplementary Note 13)

An analysis system comprising:
the analysis apparatus according to any one of Supplementary Notes 1 to 12; and
an emotion data generation apparatus configured to generate emotion data of the participants and provide the emotion data for the analysis apparatus.

(Supplementary Note 14)

An analysis method, wherein
a computer performs the following processing of:
acquiring emotion data including time data from an emotion data generation apparatus that generates the emotion data from face image data of participants in an online meeting;
acquiring meeting data regarding the meeting including the time data;
generating chapters for the meeting based on the meeting data;
generating analysis data regarding the meeting based on the emotion data for each of the chapters; and
outputting the analysis data.

(Supplementary Note 15)

A non-transitory computer readable medium storing an analysis program for causing a computer to execute the processing of:
acquiring emotion data including time data from an emotion data generation apparatus that generates the emotion data from face image data of participants in an online meeting;
acquiring meeting data regarding the meeting including the time data;
generating chapters for the meeting based on the meeting data;
generating analysis data regarding the meeting based on the emotion data for each of the chapters; and
outputting the analysis data.

### REFERENCE SIGNS LIST

10 ANALYSIS SYSTEM
90 MEETING TERMINAL GROUP
100 ANALYSIS APPARATUS
111 EMOTION DATA ACQUISITION UNIT
112 MEETING DATA ACQUISITION UNIT
113 CHAPTER GENERATION UNIT
114 ANALYSIS DATA GENERATION UNIT
115 OUTPUT UNIT
116 PERSON IDENTIFICATION UNIT
120 STORAGE UNIT
200 ANALYSIS APPARATUS
300 EMOTION DATA GENERATION APPARATUS
311 PARTICIPANT DATA ACQUISITION UNIT
312 EMOTION DATA GENERATION UNIT
313 EMOTION DATA OUTPUT UNIT
400 MEETING MANAGEMENT APPARATUS
990 USER TERMINAL
N NETWORK

What is claimed is:

1. An analysis apparatus comprising:
at least one memory storing instructions, and
at least one processor configured to execute the instructions to;
acquire emotion data including time data from an emotion data generation apparatus that generates the emotion data from face image data of participants in an online meeting;
acquire meeting data regarding the meeting that includes time data;
generate chapters for the meeting based on the meeting data;
generate analysis data for the meeting based on the emotion data for each of the chapters; and
output the generated analysis data.

2. The analysis apparatus according to claim 1, wherein
the at least one processor is further configured to execute the instructions to
acquire meeting data including data regarding screen sharing in the meeting, and
generate the chapters based on the data regarding the screen sharing.

3. The analysis apparatus according to claim 2, wherein
the at least one processor is further configured to execute the instruction to
generate the chapters in accordance with a timing when the screen sharing is switched.

4. The analysis apparatus according to claim 2, wherein
the at least one processor is further configured to execute the instruction to
generate the chapter in accordance with a time when the owner of the shared screen in the screen sharing is switched.

5. The analysis apparatus according to claim 1, wherein
the at least one processor is further configured to execute the instruction to
acquire meeting data including screen data shared in the meeting.

6. The analysis apparatus according to claim 1, wherein
the at least one processor is further configured to execute the instruction to
acquire the meeting data from a meeting management apparatus that manages the meeting.

7. The analysis apparatus according claim 1, wherein
the at least one processor is further configured to execute the instructions to
acquire meeting data including attribute data of the meeting, and
generate the analysis data by selecting a method for calculating the analysis data based on the attribute data.

8. The analysis apparatus according to claim 7, wherein
the at least one memory is further configured to store
storing analysis history data regarding the analysis data that has been generated in the past, and the at least one processor is configured to execute the instruction to
generate the analysis data including a result of a relative comparison of the meeting that corresponds to the attribute data based on the attribute data of the meeting and the analysis history data.

9. The analysis apparatus according claim 1, wherein
the at least one processor is further configured to execute the instructions to
identify a person based on face image data,
acquire the face image data of the participant,
identify segmentation to which the participant belongs from the face image data, and
generate the analysis data in view of the segmentation.

10. The analysis apparatus according to claim 1, wherein
the at least one processor is further configured to execute the instructions to identify a person based on face image data,
acquire the face image data of the participant,
identify the participant from the face image data, and
generate the analysis data of the participant regarding the identification.

11. The analysis apparatus according to claim 1, wherein
the at least one processor is further configured to execute the instructions to
acquire the emotion data in which a plurality of indices indicating the states of the emotions are indicated by numerical values, and
generate the analysis data by calculating a statistical value of the emotion data in a predetermined period.

12. The analysis apparatus according to claim 1, wherein
the at least one processor is further configured to execute the instructions to
acquire the emotion data in which a plurality of indices indicating the states of the emotions are indicated by numerical values, and
generate data in which a plurality of pieces of the emotion data are shown as color tones based on a preset index as the analysis data.

13. An analysis system comprising:
the analysis apparatus according to claim 1; and
an emotion data generation apparatus configured to generate emotion data of the participants and provide the emotion data for the analysis apparatus.

14. An analysis method, wherein
a computer performs the following processing of:
acquiring emotion data including time data from an emotion data generation apparatus that generates the emotion data from face image data of participants in an online meeting;
acquiring meeting data regarding the meeting including the time data;
generating chapters for the meeting based on the meeting data;
generating analysis data regarding the meeting based on the emotion data for each of the chapters; and
outputting the analysis data.

15. (canceled)

16. The analysis method according to claim 14, the computer further performs the following processing of:
acquiring meeting data including data regarding screen sharing in the meeting, and
generating the chapters based on the data regarding the screen sharing.

17. The analysis method according to claim 16, the computer further performs the following processing of:
generating the chapters in accordance with a timing when the screen sharing is switched.

18. A non-transitory computer readable medium storing an analysis program for causing a computer to execute the processing of:
acquiring emotion data including time data from an emotion data generation apparatus that generates the emotion data from face image data of participants in an online meeting;
acquiring meeting data regarding the meeting including the time data;
generating chapters for the meeting based on the meeting data;
generating analysis data regarding the meeting based on the emotion data for each of the chapters; and
outputting the analysis data.

19. A non-transitory computer readable medium storing an analysis program according to claim 18, wherein the program for causing the computer to execute the further processing of
acquiring meeting data including data regarding screen sharing in the meeting, and
generating the chapters based on the data regarding the screen sharing.

20. A non-transitory computer readable medium storing an analysis program according to claim 19, wherein the program for causing the computer to execute the further processing of
generating the chapters in accordance with a timing when the screen sharing is switched.
